(19) United States
(12) Patent Application Publication
(10) Pub. No.: US 2008/0085151 A1
(43) Pub. Date: Apr. 10, 2008

(54) LIGHT WEIGHT BALL JOINT

(76) Inventor: Jiri V. Pazdirek, Schaumburg, IL (US)

Correspondence Address: The MacLean-Fogg Company;c/o The Alden Law Group, 2122 York Rd, Suite # 180, Oak Brook, IL, 60523, US

(21) Appl. No.: 11/538,785

(22) Filed: Oct. 4, 2006

(51) Int. Cl. F16D 1/12

(52) U.S. Cl. 403/134

(57) ABSTRACT

The present invention relates to a ball joint including a boot, a ball stud, and a socket. The boot includes a first retaining surface and a second retaining surface. The ball stud includes a stem and a ball portion. The stem is provided with a threaded surface and a boot cooperating surface that cooperates with the first retaining surface on the boot to secure the boot to the stem. The ball portion is provided with a first bearing surface and a second bearing surface. The first bearing surface on the ball portion is generally spherically convex and the second bearing surface on the ball portion is generally spherically concave. The socket includes a first bearing surface that receives loads from the first bearing surface on the ball portion, a second bearing surface that receives loads from the second bearing surface on the ball portion, and a boot cooperating surface that cooperates with the second retaining surface on the boot to secure the boot to the socket.

### FIELD OF THE INVENTION

This invention relates to ball joints, and, particularly, to low weight ball joints.

### BACKGROUND OF THE INVENTION

Ball joints are typical components in a vehicle suspension system. Vehicle suspension assembly components are classified as unsprung vehicle weight, whereas the vehicle body, engine, and other parts above the suspension springs are classified as sprung vehicle weight. For improved vehicle handling and safety, especially at high vehicle speeds, it is highly desirable for the unsprung vehicle weight to be as low as possible. In addition to the foregoing advantage, low weight increases the fuel efficiency and reduces manufacturing costs due to the use of less material in the components.

The presently preferred embodiment is directed at providing a low weight ball joint.

### SUMMARY OF THE INVENTION

The scope of the present invention is defined solely by the appended claims, and is not affected to any degree by the statements within this summary. Briefly stated, a ball joint embodying features of the present invention comprises a boot, a ball stud, and a socket. The boot includes a first retaining surface and a second retaining surface. The ball stud includes a stem and a ball portion. The stem is provided with a threaded surface and a boot cooperating surface that cooperates with the first retaining surface on the boot to secure the boot to the stem. The ball portion is provided with a first bearing surface and a second bearing surface. The first bearing surface on the ball portion is generally spherically convex and the second bearing surface on the ball portion is generally spherically concave. The socket includes a first bearing surface that receives loads from the first bearing surface on the ball portion, a second bearing surface that receives loads from the second bearing surface on the ball portion, and a boot cooperating surface that cooperates with the second retaining surface on the boot to secure the boot to the socket.

### BRIEF DESCRIPTION OF THE DRAWINGS

FIG. 1 depicts a ball joint of the presently preferred embodiment, partially in section.

FIG. 2 depicts a perspective view of a ball stud of the presently preferred embodiment.

FIG. 3 depicts a sectional view of a ball stud of the presently preferred embodiment.

FIG. 4 depicts a sectional view of a boot of an alternative embodiment.

FIG. 5 depicts a sectional view of a boot of the presently preferred embodiment.

FIG. 6 depicts a perspective view of a ball stud of the presently preferred embodiment.

FIG. 7 depicts a sectional view of a socket of the presently preferred embodiment.

FIG. 8 depicts perspective view of a ball stud and a sectional view of the first socket member of the presently preferred embodiment.

FIG. 9 depicts a ball joint of the presently preferred embodiment, partially in section.

FIG. 10 depicts a sectional view of a second socket member of an alternative embodiment.

FIGS. 11A-11E depict a slug progression for cold forming a ball stud of the presently preferred embodiment.

FIG. 12 depicts a ball stud of an alternative embodiment

FIG. 13 depicts a sectional view of a ball portion of a ball stud of an alternative embodiment.

FIG. 14 depicts a sectional view of a stem of a ball stud of an alternative embodiment.

FIG. 15 depicts a ball portion and ball stud of an alternative embodiment

FIGS. 16A-16E depict a slug progression for cold forming a ball portion of an alternative embodiment.

FIGS. 17A-17E depict a slug progression for cold forming a stem of an alternative embodiment.

FIG. 18 depicts a sectional view of a ball portion of a ball stud of an alternative embodiment.

FIG. 19 depicts a sectional view of a ball portion and a stem of a ball stud of an alternative embodiment.

FIG. 20 depicts a sectional view of a ball portion of a ball stud of an alternative embodiment.

FIG. 21 depicts a suspension wheel knuckle on a vehicle suspension system.

### DETAILED DESCRIPTION OF THE PRESENTLY PREFERRED EMBODIMENTS

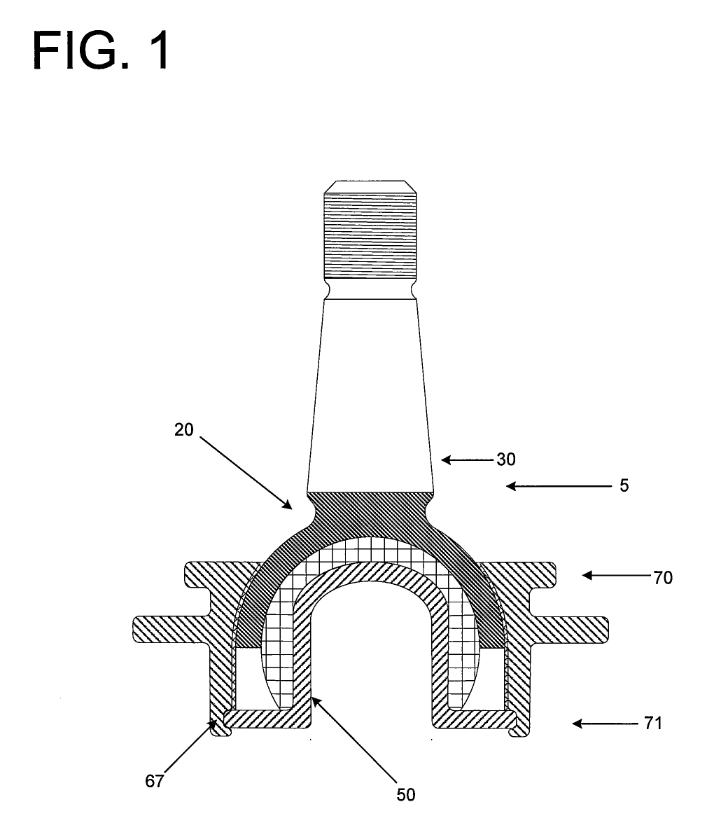

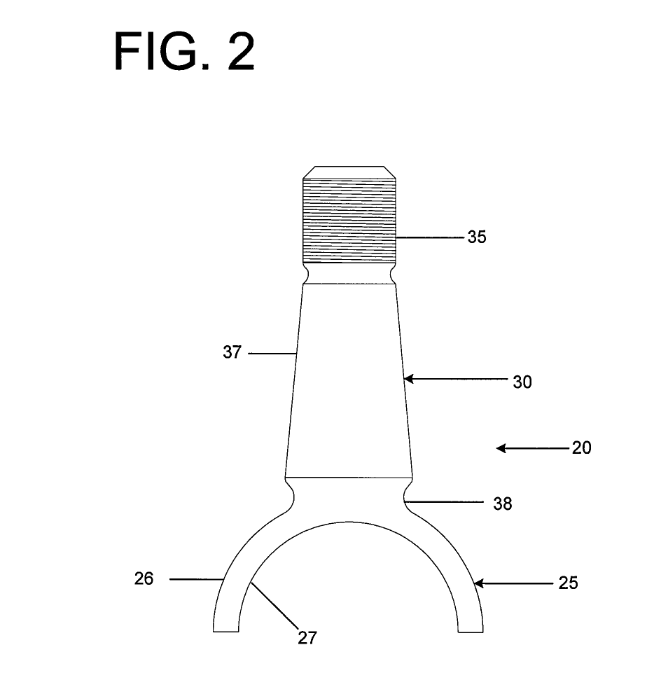

FIG. 1 depicts the presently preferred embodiment of the ball joint 5. As shown therein, the ball joint 5 includes a ball stud 20. As shown in FIG. 2 the ball stud 20 is provided with a ball portion 25.

According to one aspect of the presently preferred embodiment, ball portion 25 is configured to be housed by the socket 50. According to another aspect of the presently preferred embodiment, the ball portion 25 is configured to pivot within the socket 50. As shown in FIG. 2, the ball portion 25 is provided with a first bearing surface 26. The first bearing surface 26 is preferably located adjacent to a stem 30 of the ball stud 20 and provide with a generally spherically convex shape.

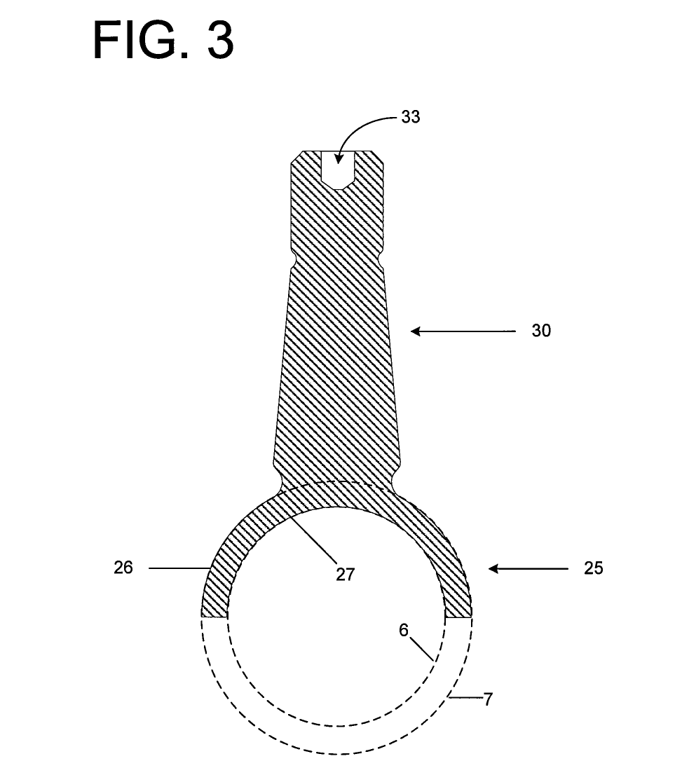

As shown in FIG. 2, the ball portion 25 is provided with a second bearing surface 27. According to one aspect of the presently preferred embodiment, the second bearing surface 27 is shaped to reduce the weight of the ball stud 20. According to another aspect of the presently preferred embodiment, the second bearing surface 27 is shaped to reduce the axial height of the ball stud 20. According to yet another aspect of the presently preferred embodiment, the second bearing surface 27 is shaped according to the first bearing surface 26. Advantageously as shown in FIG. 2, the second bearing surface 27 is provided with a generally spherically concave shape. As shown therein, the second bearing surface 27 is preferably provided with a generally hemispherical shape; however, it is within the scope of the present invention for the second bearing surface to have less than a hemispherical shape or greater than a hemispherical shape. Preferably, as shown in FIG. 3, the second bearing surface 27 is shaped to lie upon on the surface of an imaginary sphere 6 that is concentric relative to an imaginary sphere 7 that the first bearing surface 26 lies upon. As shown therein the imaginary sphere 7 is provided with a diameter that measures greater than the diameter of the imaginary sphere 6.

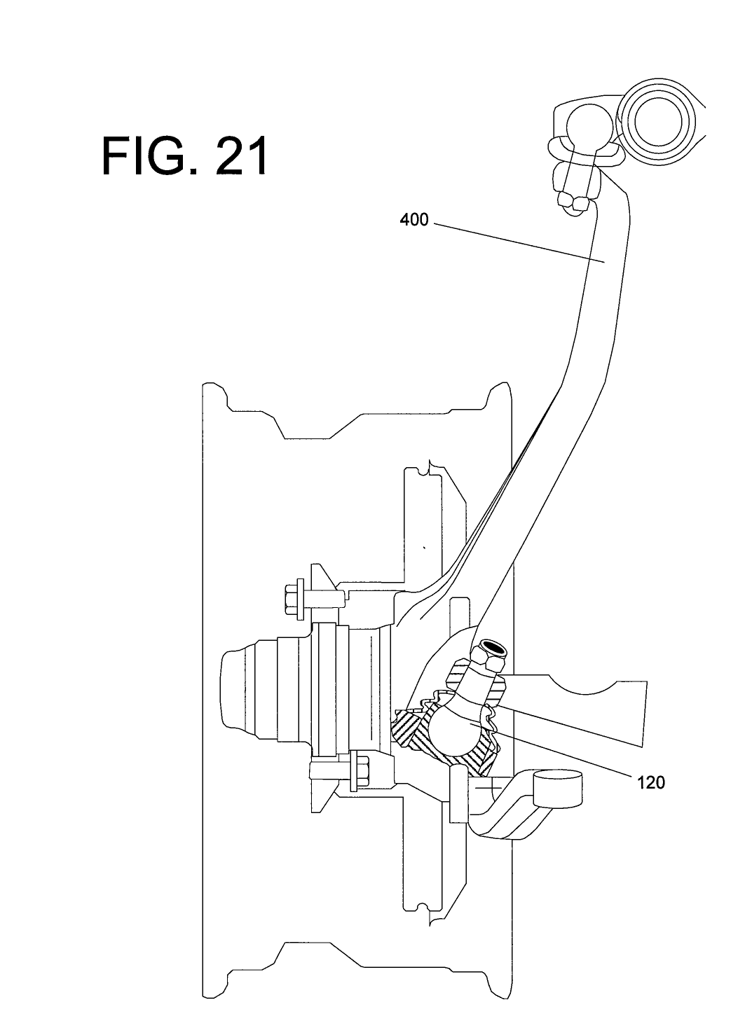

Turning now to FIG. 2, the ball stud 20 is provided with a stem 30. According to one aspect of the presently preferred embodiment, the stem 30 is configured to connect the ball joint 5 to a structural member, such as, for example, the suspension wheel knuckle 400 in an automotive vehicle shown in FIG. 21. As shown therein, the stem 30 is provided with a threaded surface 35. The threaded surface 35 is adapted to mate with a threaded nut to secure the ball joint 5 to a structural member. Furthermore, as shown in FIG. 3, the stern 30 is provided with a torque transmitting surface 33. As shown therein, in the preferred embodiment, the torque transmitting surface 33 is an internal drive that is generally hexagonal in shape; however, it is within the scope of the present invention to provide the torque transmitting surface 33 with other shapes, such as, for example, a hexagonal shape in the form of an external drive, or to fabricate the stem 30 without the torque transmitting surface 33.

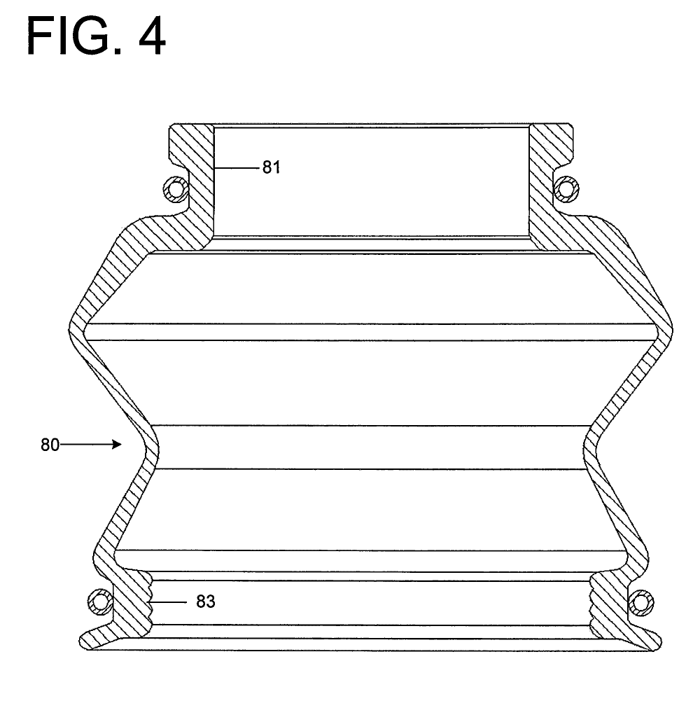

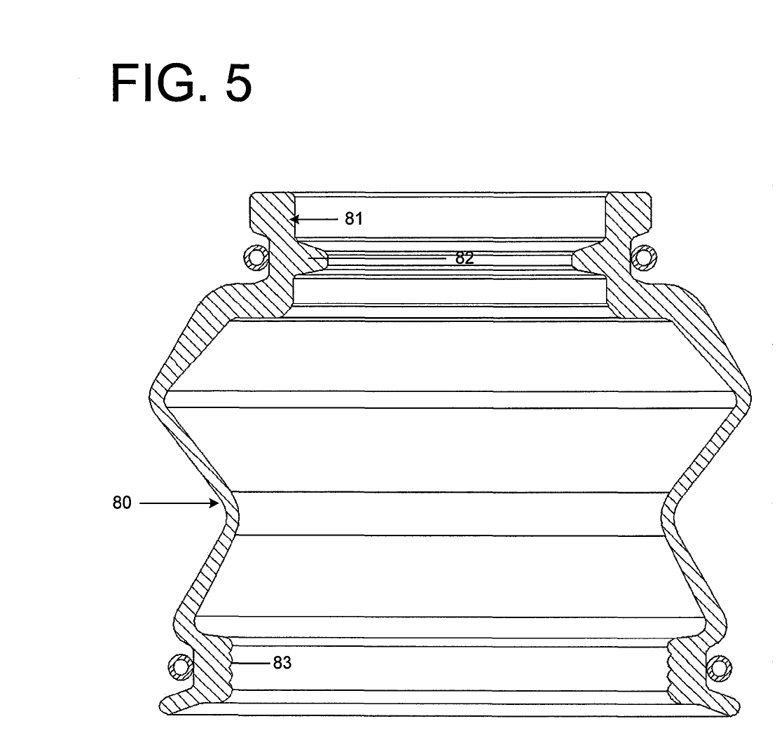

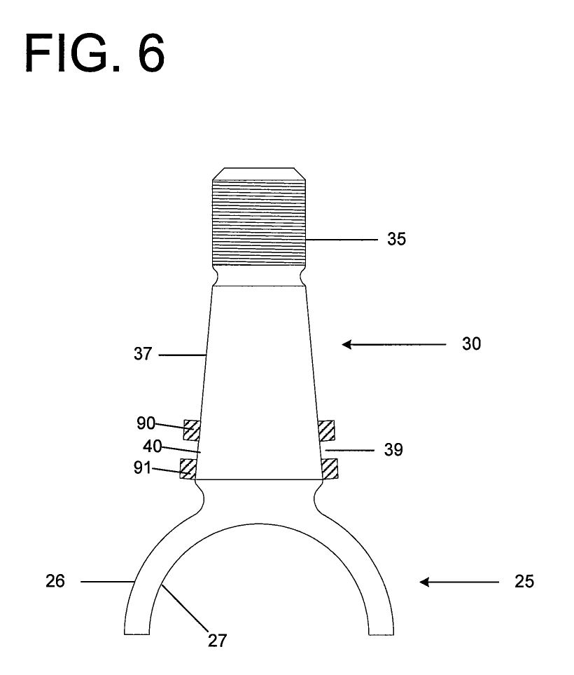

According to another aspect of the presently preferred embodiment, the stem 30 is configured to retain a boot 80 on the ball stud 20. Those skilled in the art will appreciate that it is within the scope of the present invention to retain the boot on the stem 30 using any suitable arrangement. By way of example, FIG. 4 depicts a boot 80 that is provided with a first retaining surface 81 that is dimensioned to extend elastically around at least a portion of the stem 30, such as, for example, around the boot cooperating surface 37 of the stem 30 shown in FIG. 2. As shown in FIG. 2 the surface 37 is generally frusto-conical in shape, however, it is within the scope of the present invention to provide the boot cooperating surface 37 with other shapes, such as, for example, a generally cylindrical shape. FIG. 5 depicts a boot 80 that is provided with a first retaining surface 81 that is provided with a protruding ridge 82 that is adapted to fit within a boot receiving portion on the stem 30, such as, for example, the boot receiving portion 39 on the stem 30 of the embodiment shown in FIG. 6. In the embodiment depicted in FIG. 6 the boot cooperating surface 37 is provided with a boot receiving portion 39 in the form of a generally annular groove defined by a generally cylindrical surface 40 and two generally annular members 90, 91, which, in the preferred embodiment, are washers that are attached to the stem 30 by being press fit to the boot cooperating surface 37; however; one or both of the generally annular members 90, 91 may be integrally provided on the stem 30.

According to yet another aspect of the presently preferred embodiment, the stem 30 is shaped to accommodate the pivoting motion of the ball stud 20 within the socket 50. As shown in FIG. 2, in the presently preferred embodiment, the stem 30 is provided with a recessed surface 38 that is located adjacent to the ball portion 25. Advantageously, the recessed surface 38 is shaped to increase the range of motion of the ball portion 25 within the socket 50. As shown therein, the recessed surface 38 is radially recessed with respect to an adjacent surface on the stem 20, which, in the embodiment depicted is the boot cooperating surface 37. The recessed surface 38 is shown provide with a preferable generally V shape.

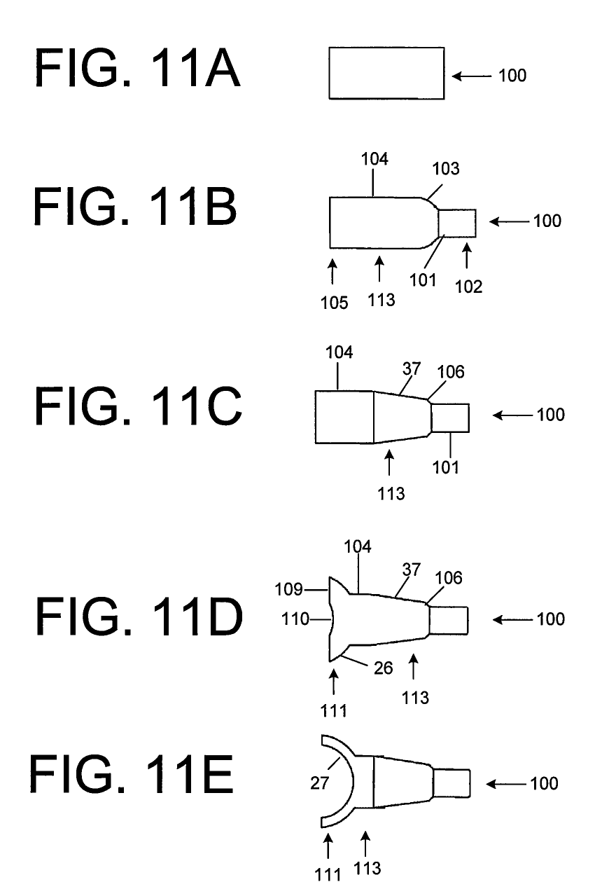

The ball stud 20 of the presently preferred embodiment is preferably fabricated through cold forming. FIGS. 11A-11E depict the presently preferred slug progression for cold forming the ball stud 20. As shown in 11A, the preferred process for cold forming begins by cutting off a piece of metal 100 from a wire stock, such as grade 4140 steel. As shown therein, the piece of metal 100 is provided with a generally cylindrical outer surface.

Afterwards, as shown in FIG. 11B, the metal 100 is extruded to provide a body 113 that includes a first generally cylindrical surface 101 at the first end 102 of the piece of metal and generally curved surface 103. As shown, the curved surface 103 is located adjacent to the first generally cylindrical surface 101 and a second generally cylindrical surface 104, which is located at the second end 105 and provided with a diameter that measures greater than the diameter of the first generally cylindrical surface 101.

As shown in FIG. 11C, the metal 100 is subsequently extruded to provide a frusto-conical surface 106 and the boot cooperating surface 37. Afterwards, as shown in FIG. 11D, a portion the second cylindrical surface 104 is upset to provide a head 111 that includes the first bearing surface 26, a generally annular surface 109, and a generally spherically concave surface 110, from which the generally annular surface 109 extends radially outward.

Subsequently, as shown in FIG. 11E, the head 111 is upset and the generally annular surface 109 and spherically concave surface 110 are reworked to provide the second bearing surface 27. Afterwards, the head 111 and body 113 are preferably coined so that the ball stud 20 is provided with a near net finish shape or a net finish shape.

Thereafter, the cylindrical surface 104 is machined or roll formed to provide the recessed surface 38 and threads are rolled into the cylindrical surface 101 to provide the threaded surface 35. Additionally, further desirable finishing may also be performed, such as, for example, grinding the ball portion 25 or heat treating the ball stud 120. Although the presently preferred embodiment is fabricated through cold forming, it is within the scope of the present invention to fabricate the ball stud 20 through any suitable method, such as casting, hot forming, cold forming, and machining, and any combination thereof can used.

Turning now to FIG. 1, the ball joint 5 of the presently preferred embodiment is provided with a socket 50. As shown therein, the socket 50 is preferably a multi-piece assembly; however, it is within the scope of the present invention to fabricate the socket 50 out of any number of components.

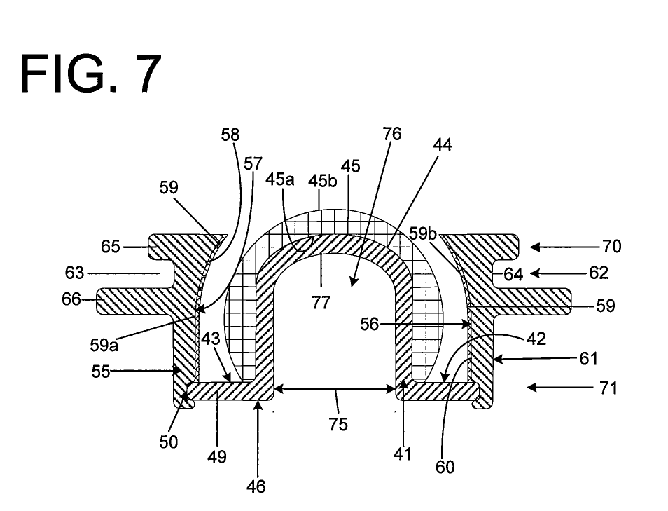

Turning now to FIG. 7, the socket 50 of the presently preferred embodiment shown provided with a first socket member 55. As shown therein, the first socket member 55 includes an inner surface 56. According to one aspect of the presently preferred embodiment, the inner surface 56 is dimensioned to accommodate the ball portion 25 of the ball stud 20. According to another aspect of the presently preferred embodiment, the inner surface 56 is shaped so that the ball portion 25 is able to pivot within the socket 50. According to yet another aspect of the presently preferred embodiment, the inner surface 56 is shaped to receive loads from the ball portion 25.

As shown in FIG. 7, the inner surface 56 includes a ball accommodating portion 57. The ball accommodating portion 57 of the presently preferred embodiment includes a bearing surface 58. According to one aspect of the presently preferred embodiment, the bearing surface 58 is shaped to receive loads from the ball portion 25. According to another aspect of the presently preferred embodiment, the bearing surface 58 is shaped to receive loads from the first bearing surface 26 of the ball portion 25. According to yet another aspect of the presently preferred embodiment, the bearing surface 58 is shaped to accommodate the pivoting motion of the ball portion 25. According to still another aspect of the presently preferred embodiment, the bearing surface 58 is shaped to accommodate the pivoting motion of the first bearing surface 26 of the ball portion 25.

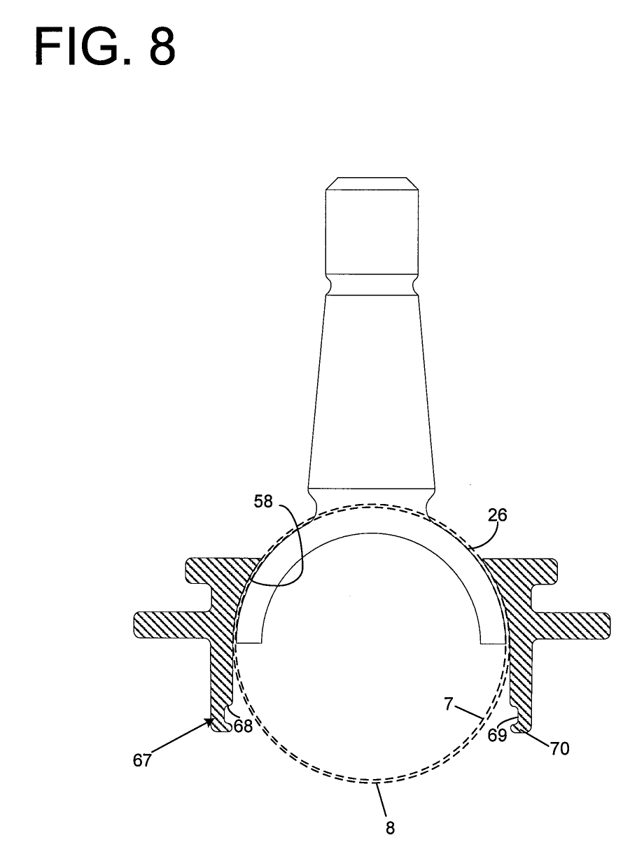

As shown in FIG. 7, the bearing surface 58 is preferably provided with a generally spherically concave shape. In the preferred embodiment, as shown in FIG. 8, the bearing surface 58 is shaped to lie upon on the surface of an imaginary sphere 8 that is concentric relative to an imaginary sphere 7 that the first bearing surface 26 lies upon. As shown therein the imaginary sphere 8 is provided with a diameter that measures greater than the diameter of the imaginary sphere 7.

Preferably, as shown in FIG. 7 the socket 50 includes a low friction material 59 that is located between the bearing surface 58 and the first bearing surface 26 on the ball portion 25. As shown, the low friction material 59 is provided with first and second bearing surfaces 59a, 59b, which are preferably shaped to be generally complementary to the respective bearing surfaces 58, 26. The low friction material 59 can include any material having a frictional coefficient that is lower than the surface to which it is applied, such as, for example, a material including Polyacetal, such as Delrin® manufactured by DuPont, a material including Teflon®, or a metal screen impregnated with a low friction material 59. The low friction material 59 is preferably molded, press fit, or coated onto one or both of the bearing surfaces 58, 26. An adhesive may also be used. By way of example, the low friction material 59 may be press fit onto one or both of the bearing surfaces 58, 26 after an adhesive has been applied.

As shown in FIG. 7, inner surface 56 of the first socket member 55 includes a wall 60 that is located adjacent to the bearing surface 58 and preferably provided with a generally cylindrical shape; however; those skilled in the art will appreciate that it is within the scope of the present invention to fabricate the first socket member 55 without the wall 60 or to provide it with other shapes, so long as the ball portion 26 is able to pivot within a predetermined desired range, which will depend on the particular application for which the ball joint 5 is employed. By way of example, the inner surface 56 may be fabricated without the wall 60 and the length of the bearing surface 58 may be increased so that it extends to the second socket member receiving portion 67 (shown in FIG. 8).

As shown in FIG. 7, the first socket member 55 includes an outer surface 61. According to one aspect of the presently preferred embodiment, the outer surface 61 is configured to retain a boot 80 on the ball stud 20. Those skilled in the art will appreciate that it is within the scope of the present invention to retain the boot 80 on the outer surface 61 using any suitable arrangement. FIG. 7 depicts the outer surface 61 provided with a boot cooperating surface 62 that cooperates with at least a portion of the boot 80, such as the second retaining surface 83 shown in FIGS. 4 and 5, to secure the boot to the first socket member 55. As shown, the boot cooperating surface 62 includes two generally annular members 65, 66 and a generally cylindrical surface 64 that define a boot receiving portion 63 in the form of a generally annular groove for receiving the second retaining surface 83 on the boot 80. In the preferred embodiment, the annular members 65, 66 are integrally provided on the first socket member 55; however; one annular or both of the generally annular members 65, 66 may be fabricated separately and attached to the outer surface 61, such as, for example, by being press-fit.

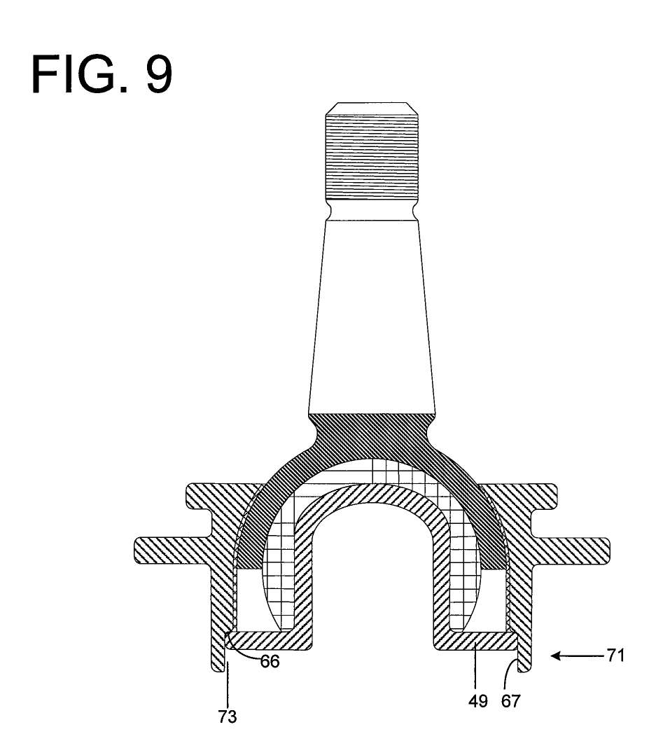

According to another aspect of the presently preferred embodiment, the first socket member 55 of the presently preferred embodiment is adapted to secure and support the second socket member 41. As shown in FIG. 1, the stem 30 of the ball stud 20 extends axially away from the first end 70 of the first socket member 55 and, preferably, a second socket member receiving portion 67 is defined at the second end 71 of the first socket member 55. In the preferred embodiment depicted in FIG. 8, the second socket member receiving portion 67 is a generally annular groove defined by a shoulder 68, a crimped portion 72, and a wall 69, which is preferably generally cylindrical in shape. As shown in FIG. 9, the crimped portion 68 is preferably provided by placing the flange 49 of the second socket member 41 within a channel 73 defined by the shoulder 66 and the wall 67 and then deforming the second end 71 of the first socket member 55 so that it extends radially inward and under the second socket member flange 49, as shown in FIG. 1.

Turning now to FIG. 7, the socket 50 of the presently preferred embodiment shown provided with a second socket member 41. As shown therein, the second socket member 55 includes an inner surface 42. According to one aspect of the presently preferred embodiment, the inner surface 42 is dimensioned to accommodate the ball portion 25 of the ball stud 20. According to another aspect of the presently preferred embodiment, the inner surface 42 is shaped so that the ball portion 25 is able to pivot within the socket 50. According to yet another aspect of the presently preferred embodiment, the inner surface 42 is shaped to receive loads from the ball portion 25.

As shown in FIG. 7, the inner surface 42 includes a ball accommodating portion 43.

The ball accommodating portion 43 of the presently preferred embodiment includes a bearing surface 44. According to one aspect of the presently preferred embodiment, the bearing surface 44 is shaped to receive loads from the ball portion 25. According to another aspect of the presently preferred embodiment, the bearing surface 44 is shaped to receive loads from the second bearing surface 27 of the ball portion. According to yet another aspect of the presently preferred embodiment, the bearing surface 44 is shaped to accommodate the pivoting motion of the ball portion 25. According to still another aspect of the presently preferred embodiment, the bearing surface 44 is shaped to accommodate the pivoting motion of the second bearing surface 27 of the ball portion 25.

In the preferred embodiment the inner surface 42 is provided with a bearing surface 44 that is provided with a curved shape. As shown in FIG. 7, the bearing surface 44 is generally convex and provided with a generally “U” shape; however, it is within the scope of the present invention for the bearing surface to be provided with other shapes. By way of example, the bearing surface 44 may be provided with a generally spherically concave shape that is shaped to lie upon on the surface of an imaginary sphere that is concentric and provided with a smaller diameter relative to an imaginary sphere that the second bearing surface 27 lies upon.

Preferably, as shown in FIG. 7, the socket 50 includes a low friction material 45 that is located between the bearing surface 44 and the second bearing surface 27 on the ball portion 25. As shown, the low friction material 45 is provided with first and second bearing surfaces 45a, 45b, which are preferably shaped to be generally complementary to the respective bearing surfaces 44, 27. The low friction material 45 can include any material having a frictional coefficient that is lower than the surface to which it is applied, such as, for example, a material including Polyacetal, such as Delrin® manufactured by DuPont, a material including Teflon®, or a metal screen impregnated with a low friction material 45. The low friction material 45 is preferably molded, press fit, or coated onto one or both of the bearing surfaces 44, 27. Additionally, an adhesive may also be used. By way of example, the low friction material 45 may be press fit onto one or both of the bearing surfaces 44, 27 after an adhesive has been applied.

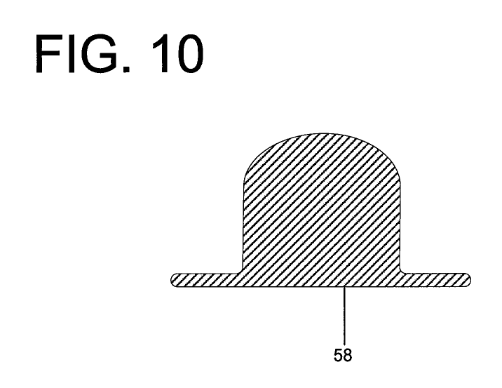

Turning now to FIG. 7, the second socket member 41 includes an outer surface 46. In the embodiment depicted, the outer surface 46 is shaped to reduce the weight and material in the second socket member 55. As shown in FIG. 7, the outer surface 46 includes a corresponding surface 47 that corresponds to the shape of the bearing surface 44 and defines an opening 75 and a cavity 76 that is closed at an end 77. Those skilled in the art will appreciate the outer surface 46 may be provided with other shapes, by way of example, FIG. 10 depicts the outer surface provided with a generally flat disc shaped surface 48.

Turning now to FIG. 7, the second socket member 41 is adapted to be connected to the first socket member 55. In the presently preferred embodiment, the second socket member 41 is preferably provided with a flange 49 that is located on the inner and outer surfaces 42, 46. As shown in FIG. 7, the flange 49 extends radially outward relative to the bearing surface 44. In the preferred embodiment, the ball joint 5 is assembled by first inserting the ball stud 30 into the first socket member 55 from the second end 71. Afterwards, the second socket member 41 is inserted into the first socket member 55 from the second end 71. Then the second end 71 of the first socket member 55 is crimped under the outer surface 46 of the flange 49 to secure the second socket member 41 to the first socket member 55.

According to one aspect of the presently preferred embodiment, the first and second socket members 55, 41 are fabricated from a metal. According to one aspect of the presently preferred embodiment the first and second socket members 55, 41 are fabricated from a steel, such as, for example, grades 1018 through 1040. According to one aspect of the presently preferred embodiment the first and second socket members 55, 41 are fabricated from an aluminum, preferably, an aluminum having a rate elongation that is at least 4%, such as grade 6061. According to another aspect of the presently preferred embodiment, the first and second socket members 55, 41 are fabricated through a cold forming stamping process; however it is within the scope of the present invention to fabricate the second socket member 41 via other methods, such as machining, casting, hot forming, and cold forming, or any combination thereof.

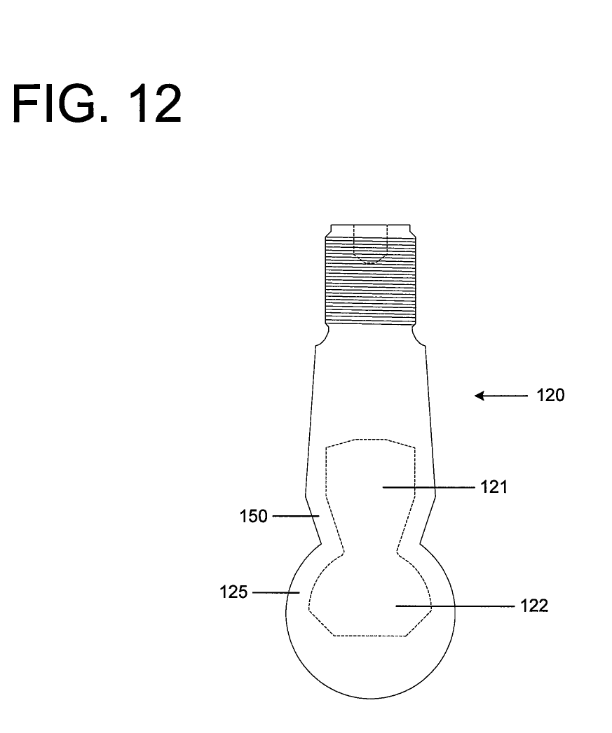

Turning now to FIG. 12, a ball stud 120 of an alternative embodiment is depicted. Advantageously, the ball stud 120 is provided with a plurality of cavities 121, 122, which reduce the weight of the ball stud 120 and decrease the amount of material used to fabricate the ball stud 120.

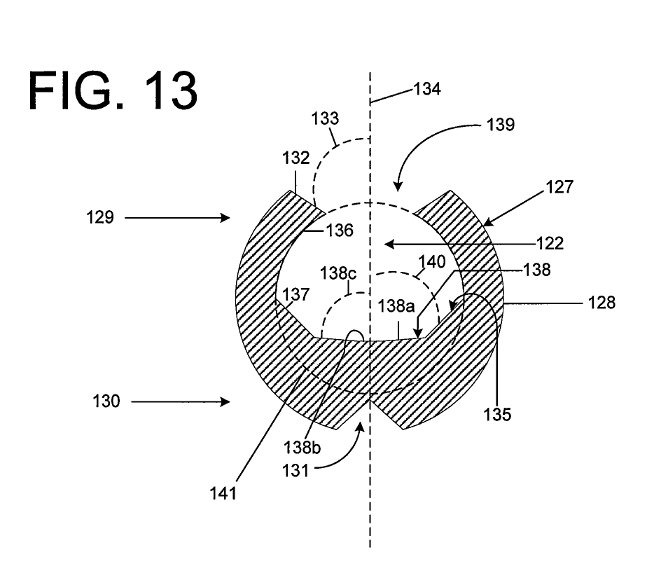

As shown in FIG. 1, the ball stud 120 is provided with a ball portion 125. FIG. 13 depicts the ball portion 125 in section prior to its attachment to the stem 150 of the ball stud 120. As shown therein, the ball portion 125 is provided with an outer surface 127. According to one aspect of the present embodiment, the outer surface is shaped to pivot within a socket, such as the sockets 520, 534, 537, and 539 disclosed in application Ser. No. 10/861,050, filed Jun. 4, 2004, the disclosure of which is hereby incorporated herein by reference. As shown in FIG. 13, the outer surface 127 is provided with a generally spherically convex surface 128 that is adapted to fit and pivot within a socket.

As shown in FIG. 13, the outer surface 127 defines a recess 131 at a second end 130 of the ball portion 125. In the preferred alternative embodiment depicted, the recess 131 is provided so that tool can hold the ball portion 125 during a cold forming operation. Accordingly, the recess is shaped according to a tool utilized during this operation and is shown provided with a generally conical shape; however, it is within the scope of the present invention to provide the recess 131 with other shapes or to fabricate the ball portion 125 without the recess.

According to another aspect of the present embodiment, the outer surface 127 is configured to be welded to a stem 150 of the ball stud 129. As shown in FIG. 13, located at the first end 129 of the ball portion 125 is a weld surface 132. In the embodiment depicted, the weld surface 132 is shaped complementary to a weld surface 164 on the stem 150. In the embodiment depicted, the weld surface 132 is generally frusto-conical in shape. As shown in FIG. 13, the weld surface 132 extends at an angle 133 relative to the axis 134 of the ball portion 125. In the embodiment depicted, the angle 133 measures from 30° to 60°, and is preferably 45°. However, it is within the scope of the present invention to provide the weld surface 132 with other shapes, such as, for example, a curved shape.

As shown in FIG. 13, the ball portion 125 is provided with an inner surface 135. According to one aspect of the present embodiment, the inner surface 135 is shaped to reduce the weight of the ball portion 125. As shown in FIG. 13, the inner surface 135 defines the cavity 122. In the embodiment depicted, the cavity 122 is defined by a plurality of surfaces 136, 137, and 138. The inner surface 135 is preferably provided with a curved surface 136 that is located adjacent to an opening 139. In the embodiment depicted, the curved surface 136 is generally concave in shape, and, preferably, generally spherically concave in shape. The curved surface 136 is preferably shaped to lie on the surface of sphere 141 which is generally concentric to the generally spherically convex surface 128 located on the outer surface 127. As shown in FIG. 13, located adjacent to the curved surface 136 is a frusto-conical surface 137. The frusto-conical surface 137 is at an angle 140 with respect to an axis 134 of the ball portion 125. The angle 140 ranges from 130° to 140°, and is preferably 135°. Located adjacent to the frusto-conical surface 137 is a terminal surface 138 that is provided with generally frusto-conical surface 138a and surface 138b that is generally circular in shape and generally orthogonal to the axis 134. The generally frusto-conical shaped surface 138a is at an angle 138c relative to the axis 134 of the ball portion 125. The angle 138c ranges from 82° to 86°, and preferably is 85°. In an alternative embodiment, the terminal surface 138 is generally conical in shape and includes a conical surface that is at an angle, relative to the axis 134, which ranges from 82° to 86°, and preferably is 85°.

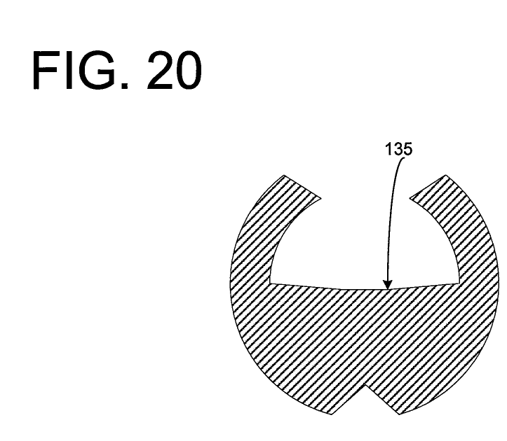

Those skilled in the art will appreciate that it is within the scope of the present invention to provide the inner surface 135 with other shapes that define a cavity 122. By way of example, FIG. 20 depicts the inner surface 135 fabricated without the frusto-conical surface 137.

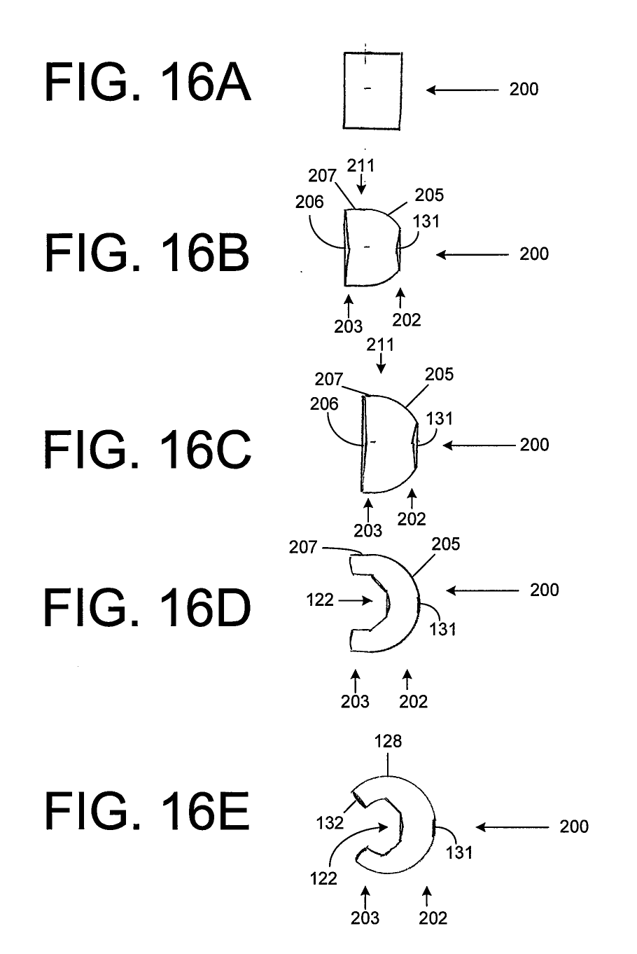

The ball portion 125 of the presently preferred embodiment is preferably fabricated through cold forming. FIGS. 16A-16E depict the presently preferred slug progression for cold forming the ball portion 125. As shown in FIG. 16A, the preferred process for cold forming begins by cutting off a piece of metal 200 from a wire stock, preferably a metal 200 that is suited to be welded to the material of the stem 150, such as a metal including a steel, for example, a grade ranging from 1010 through 1030, or a metal including an aluminum, such as grade 6061. As shown therein, the piece of metal 200 is provided with a generally cylindrical outer surface.

Afterwards, as shown in FIG. 16B, the metal is pre-formed into a body 211 that is squared to provide the recess 131 at a first end 202 and a generally conical surface 206 at a second end 203. Extending from the first end 202 is a curved surface 205, which is preferably spherical convex in shape. Located adjacent to the curved surface 206 is a cylindrical surface 207. Then, as shown in FIG. 16C, the body 211 is upset to enlarge the diameter of the second end 203 and provide the curved surface 207 with a diameter that substantially equals the finished diameter of the generally spherically convex surface 128.

As shown in FIG. 16D, a cavity 122 is then extruded into the second end 203 of the body 211, and, as shown in FIG. 16E, the second end 203 is closed so that the body 211 is provided with the generally spherically convex surface 128 and a generally frusto-conical weld surface 132. Afterwards, the ball portion 125 is preferably coined so that the ball portion 125 is provided with a near net finish shape or a net finish shape. Additionally, further desirable finishing may also be performed, such as, for example, by grinding or heat treating the ball portion 125. Although the ball portion 125 of the presently preferred embodiment is preferably fabricated through cold forming, it is within the scope of the present invention to fabricate the ball portion 125 through any suitable method, such as casting, hot forming, cold forming, and machining, and any combination thereof can used.

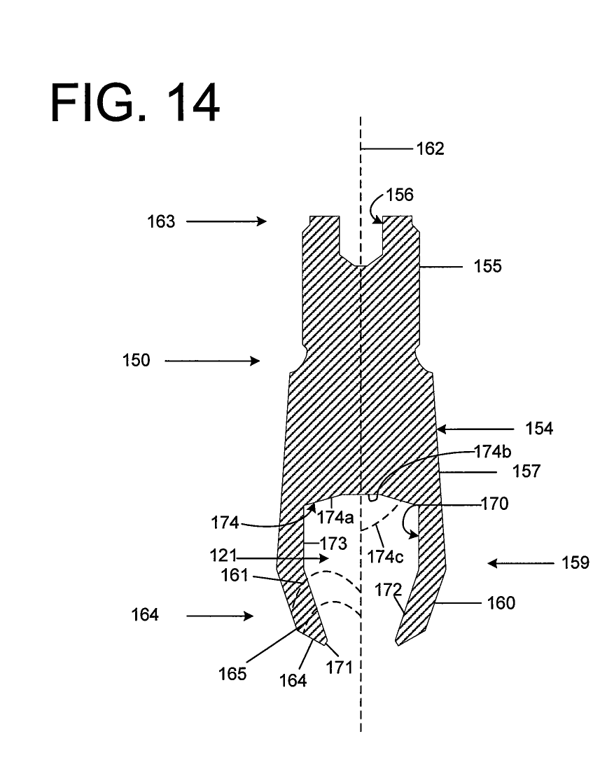

As shown in FIG. 12, the ball stud 120 is provided with a stem 150. FIG. 14 depicts the stem 150 in section prior to its attachment to the ball portion 125 of the ball stud 120. As shown therein, the stem 150 is provided with an outer surface 154. According to one aspect of the present embodiment, the outer surface 154 is configured to connect the ball stud 120 to a structural member, such as, for example, the suspension wheel knuckle 400 of an automotive vehicle shown in FIG. 21.

As shown in FIG. 14, the outer surface 154 of the stem 150 includes a threaded surface 155. The threaded surface 155 is adapted to mate with a threaded nut to secure the ball stud 120 to a structural member. Furthermore, as shown in FIG. 14, the outer surface 154 is provided with a torque transmitting surface 156, which in the embodiment depicted is located at the first end 163 of the stem 150. As shown therein, in the preferred embodiment, the torque transmitting surface 156 is an internal drive that is generally hexagonal in shape; however, it is within the scope of the present invention to provide the torque transmitting surface 156 with other shapes, such as, for example, a hexagonal shape in the form of an external drive, or to fabricate the stem 150 without the torque transmitting surface 156.

According to another aspect of the presently preferred embodiment, the outer surface 154 is configured to retain a boot 80 on the ball stud 120. Those skilled in the art will appreciate that it is within the scope of the present invention to retain the boot on the stem 150 using any suitable arrangement. By way of example, FIG. 4 depicts a boot 80 that is provided with a first retaining surface 81 that is dimensioned to extend elastically around at least a portion of the stem 150, such as, for example, around the boot cooperating surface 157 of the stem 150 shown in FIG. 14. As shown in FIG. 14 the surface 157 is generally frusto-conical in shape, however, it is within the scope of the present invention to provide the boot cooperating surface 37 with other shapes, such as, for example, a generally cylindrical shape. Those skilled in the art will appreciate that it is within the scope of the present invention to provide the stem 150 with a boot cooperating surface 157 that includes a boot receiving portion, such as, for example, the boot receiving portion 39 shown in the preferred embodiment depicted in FIG. 6. Additionally, one or both of the generally annular members 90, 91 may be integrally provided on the stem 150 or fabricated separately and attached to the stem 150.

As shown in FIG. 14, in the presently preferred embodiment, the outer surface 154 is provided with a tapered portion 159, which, after the ball portion 125 is attached to the stem 150, is located adjacent to the ball portion 125 at the second end 164 of the stem 150. According to one aspect of the present embodiment, tapered portion 159 is shaped to increase the range of motion of the ball portion 125 within the socket 50. According to another aspect of the present embodiment, the tapered area 159 provides a surface for welding to the ball portion 125.

As shown in FIG. 14, the tapered portion 159 includes recessed surface 160 that is shaped to increase the range of motion of the ball portion 25 within the socket 50. As shown therein, the recessed surface is a radially recessed with respect to an adjacent surface on the stem 150, which, in the embodiment depicted is the boot cooperating surface 157. As shown, the recessed surface 160 is generally frusto-conical in shape. The recessed surface 160 in the embodiment depicted is at an angle 161 with respect to an axis 162 of the stem 150. The angle 161 ranges from 45° to 80°, and is preferably 75°.

In the embodiment depicted, a weld surface 164 is located adjacent to the recessed surface 160. The weld surface 164 is shaped complementary to a weld surface 132 on the ball portion 125. In the embodiment depicted, the weld surface 164 is generally frusto-conical in shape. As shown in FIG. 13, the weld surface 164 extends at an angle 165 relative to the axis 162 of the stem 150. In the embodiment depicted, the angle 165 measures from 30° to 60°, and is preferably 45°. However, it is within the scope of the present invention to provide the weld surface 164 with other shapes, such as, for example, a curved shape.

As shown in FIG. 14, the stem 150 is provided with an inner surface 170. According to one aspect of the present embodiment, the inner surface 170 is shaped to reduce the weight of the stem 150. As shown in FIG. 14, the inner surface 170 defines the cavity 121. In the embodiment depicted, the cavity 121 is defined by a plurality of surfaces 171, 172, 173, and 174. The inner surface 170 is provided with an opening defining surface 171, which in the embodiment depicted is provided with a generally frusto-conical shape. Located adjacent to the opening defining surface 171 is a frusto-conical surface 172. In the embodiment depicted the frusto-conical surface 172 is at an angle relative to the axis 162 that corresponds to the angle 161 of the recessed surface 160. As shown in FIG. 14, located adjacent to the frusto-conical surface 172 is a generally cylindrical surface 173. Located adjacent to the generally cylindrical is a terminal surface 174 that is provided with generally frusto-conical surface 174a and a surface 174b that is generally circular in shape and generally orthogonal to the axis 162. The generally frusto-conical shaped surface 174a is at an angle 174c relative to the axis 162 of the stem 150. The angle 174c ranges from 82° through 86°, and is preferably 85°. In an alternative embodiment, the terminal surface 174 is generally conical in shape and includes a conical surface that is at an angle, relative to the axis 162, which ranges from 82° to 86°, and preferably is 85°. Those skilled in the art will appreciate that it is within the scope of the present invention to provide the inner surface 170 with other shapes that define a cavity 121.

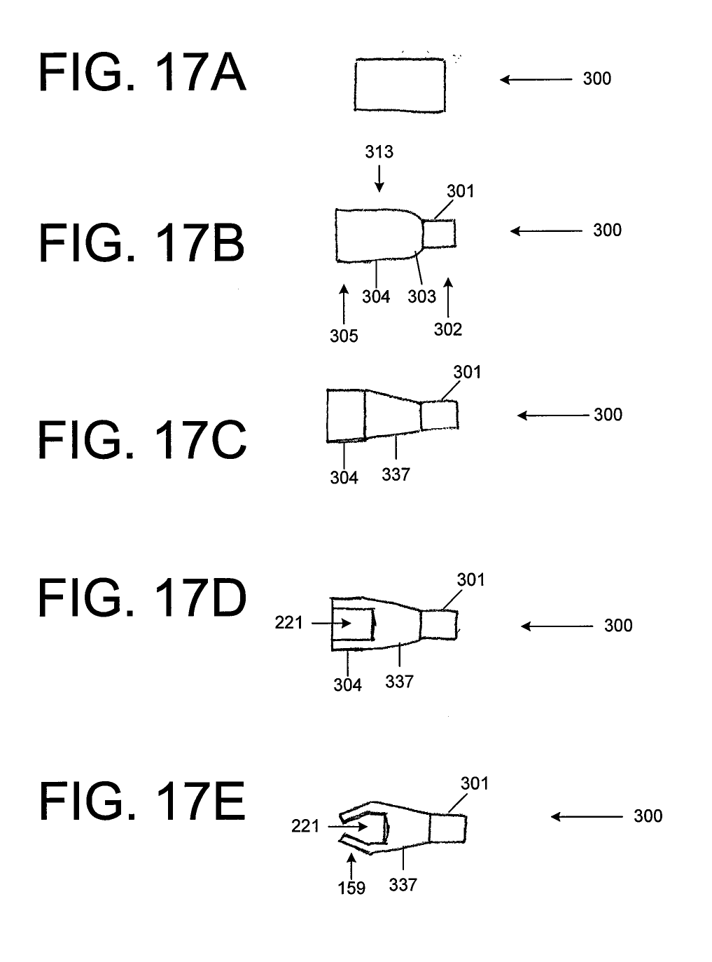

The stem 150 of the presently embodiment is preferably fabricated through cold forming. FIGS. 17A-17E depict the presently preferred slug progression for cold forming the stem 150. As shown in 17A, the preferred process for cold forming begins by cutting off a piece of metal 300 from a wire stock, preferably a metal 300 that is suited to be welded to the material of the ball portion 125 such as, a steel, for example, grades 4037 through 4140. As shown therein, the piece of metal 300 is provided with a generally cylindrical outer surface.

Afterwards, as shown in FIG. 17B, the metal 300 is extruded to provide a body 313 that includes a first generally cylindrical surface 301 at the first end 302 of the piece of metal and generally curved surface 303. As shown, the curved surface 303 is located adjacent to the first generally cylindrical surface 301 and a second generally cylindrical surface 304, which is located at the second end 305 and provided with a diameter that measures greater than the diameter of the first generally cylindrical surface 301.

As shown in FIG. 17C, the metal 300 is subsequently extruded to provide the boot cooperating surface 337. Afterwards, as shown in FIG. 17D, a portion the second end 305 is extruded to provide a cavity 121 that is generally cylindrical in shape. Subsequently, as shown in FIG. 17E, the cylindrical surface 304 is formed into the shape of the tapered portion 159. Afterwards, the stem 150 is preferably coined to provide a near net finish shape or a net finish shape.

Thereafter, threads are rolled into the cylindrical surface 301 to provide the threaded surface 155. Additionally, further desirable finishing may also be performed, such as, for example, by heat treating the stem 150. Although the stem 150 of the present embodiment is preferably fabricated from cold forming, it is within the scope of the present invention to fabricate the stem 150 through any suitable method, such as casting, hot forming, cold forming, and machining, and any combination thereof can used.

Preferably, after the ball portion 125 and stem 150 are fabricated, a coating is applied to each. According to one aspect of the present embodiment, the ball portion 125 is provided with a low friction coating. The low friction coating can be any material that is provided with a lower frictional coefficient than the surface to which it is applied to, such as, for example, a material including Teflon®. The stem 150 is preferably provided with a corrosion resistant coating. The corrosion resistant coating can be any material that is provided with greater resistance to corrosion than the surface to which it is applied to, such as, for example, a material including Zinc.

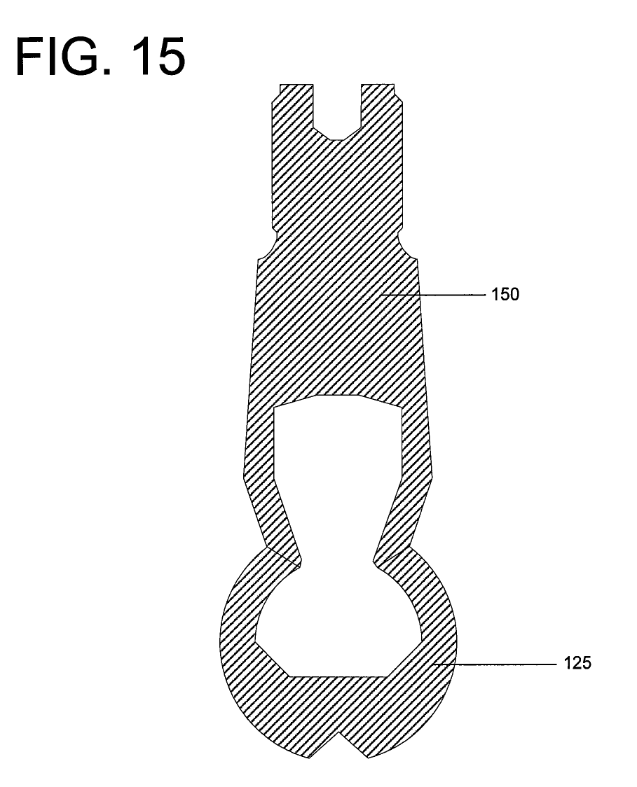

Preferably, after being applied to the ball portion125 and stem 150, the coating or coatings are removed from the weld surfaces 132, 164, such as by grinding, brushing, or buffing these surfaces. Thereafter, the ball portion125 and the stem 150 are attached to each other preferably through welding, such as, for example, friction welding or resistance welding. As shown in FIG. 15 the weld surfaces 132, 164 ate placed into contact and then welded together, as shown in FIG. 12, preferably through a form of friction welding referred to as inertia welding.

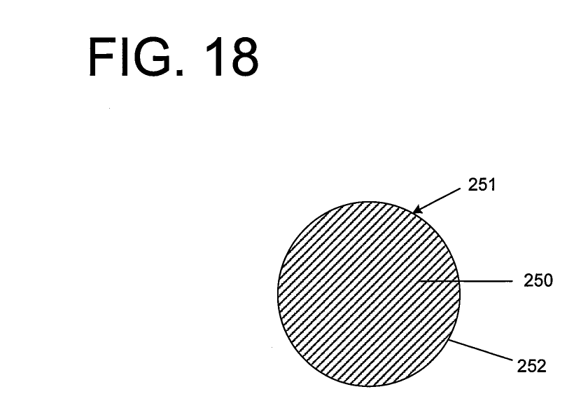

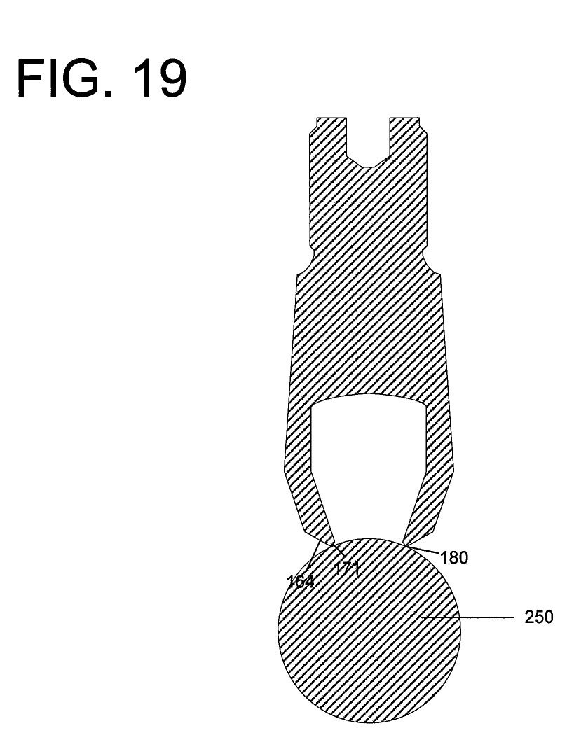

FIG. 18 depicts a sectional view of a ball 250 of an alternative embodiment. As shown therein, the ball 250 is substantially solid and provided with an outer surface 251 that is shaped to pivot within a socket. As shown the outer surface 251 includes a generally spherically convex surface 252. The outer surface 251 is adapted to be welded to the stem 150. Preferably, the ball 250 welded to the stem 150 through resistance welding. As shown in FIG. 19, the junction between the opening defining surface 171 and the weld surface 164 provides a weld projection 180 whereat the weld joint is created.

While this invention has been particularly shown and described with references to preferred embodiments thereof, it will be understood by those skilled in the art that various changes in form and details may be made therein without departing from the spirit and scope of the invention as defined by the appended claims.

I claim:

1. A ball joint comprising:
a) a boot including a first retaining surface and a second retaining surface;
b) a ball stud including a stem and a ball portion, wherein:
i) the stem is provided with a threaded surface and a boot cooperating surface that cooperates with the first retaining surface on the boot to secure the boot to the stem;
ii) the ball portion is provided with a first bearing surface and a second bearing surface, wherein the first bearing surface is generally spherically convex and the second bearing surface is generally spherically concave;
c) a socket that includes:
i) a first bearing surface that receives loads from the first bearing surface on the ball portion;
ii) a second bearing surface that receives loads from the second bearing surface on the ball portion; and
iii) a boot cooperating surface that cooperates with the second retaining surface on the boot to secure the boot to the socket.

2. The ball joint according to claim 1, further comprising a low friction material that is located between the first bearing surface on the socket and the first bearing surface on the ball portion.

3. The ball joint according to claim 1, further comprising a low friction material that is located between the second bearing surface on the socket and the second bearing surface on the ball portion.

4. The ball joint according to claim 1, further comprising a first low friction material that is located between the first bearing surface on the socket and the first bearing surface on the ball portion and a second low friction material located between the second bearing surface on the socket and the second bearing surface on the ball portion.

5. The ball joint according to claim 1, further comprising a low friction material that is located between the first bearing surface on the socket and the first bearing surface on the ball portion and between the second bearing surface on the socket and the second beating surface on the ball portion.

6. The ball joint according to claim 1, wherein the second bearing surface is provided with a generally U shape.

7. The ball joint according to claim 1, wherein the second bearing surface on the socket is provided with a generally spherically convex shape.

8. A ball joint comprising:
a) a boot including a first retaining surface and a second retaining surface;
b) a ball stud including a stem and a ball portion, wherein:
i) the stem is provided with a threaded surface and a boot cooperating surface that cooperates with the first retaining surface on the boot to secure the boot to the stem;
ii) the ball portion is provided with a first bearing surface and a second bearing surface, wherein the first bearing surface is generally spherically convex and the second beating surface is generally spherically concave;
c) a socket that includes:
i) a first socket member that is provided with:
1) a first bearing surface that receives loads from the first bearing surface on the ball portion;
2) a boot cooperating surface that cooperates with the second retaining surface on the boot to secure the boot to the socket; and
ii) a second socket member that is secured to the first socket member and provided with a second bearing surface that receives loads from the second bearing surface on the ball portion.

9. The ball joint according to claim 8, wherein the second socket member is provided with a flange that is located within a groove on the first socket member.

10. The ball joint according to claim 8, wherein the second socket member is provided with a flange that is located within a groove defined, at least in part, by a crimped portion on the first socket member.

11. A ball joint comprising:
a) a boot including a first retaining surface and a second retaining surface;
b) a ball stud including a stem and a ball portion, wherein:
i) the stem is provided with a threaded surface and a boot cooperating surface that cooperates with the first retaining surface on the boot to secure the boot to the stem;
ii) the ball portion is provided with a first bearing surface and a second bearing surface, wherein the first bearing surface is generally spherically convex and positioned to lie upon the surface of a first sphere and the second bearing surface is generally spherically concave and positioned to lie upon the surface of a second sphere that is generally concentric relative to the first sphere;
c) a socket that includes:
i) a first socket member that is provided with:
1) a first bearing surface that receives loads from the first bearing surface on the ball portion;
2) a boot cooperating surface that cooperates with the second retaining surface on the boot to secure the boot to the socket; and
ii) a second socket member that is secured to the first socket member and provided with a second bearing surface that receives loads from the second bearing surface on the ball portion.

12. The ball joint according to claim 11, wherein the second socket member is provided with a flange that is located within a groove on the first socket member.

13. The ball joint according to claim 11, wherein the second socket member is provided with a flange that is located within a groove defined, at least in part, by a crimped portion on the first socket member.

14. The ball joint according to claim 11, further comprising a low friction material that is located between the first bearing surface on the socket and the first bearing surface on the ball portion.

15. The ball joint according to claim 11, further comprising a low friction material that is located between the second bearing surface on the socket and the second bearing surface on the ball portion.

16. The ball joint according to claim 11, further comprising a low friction material that is located between the first bearing surface on the socket and the first bearing surface on the ball portion and between the second bearing surface on the socket and the second bearing surface on the ball portion.

17. The ball joint according to claim 11, wherein the second bearing surface is provided with a generally U shape.

18. The ball joint according to claim 11, wherein the second bearing surface on the socket is provided with a generally spherically convex shape.

19. The ball joint according to claim 11, wherein the second bearing surface is located on an inner surface of the second socket member and an outer surface of the second socket member defines a cavity that is generally U shaped in section and provided with an opening and a closed end.

20. The ball joint according to claim 11, further comprising a first low friction material that is located between the first bearing surface on the socket and the first bearing surface on the ball portion and a second low friction material located between the second bearing surface on the socket and the second bearing surface on the ball portion.
